(19) United States
(12) Patent Application Publication
(10) Pub. No.: US 2007/0281871 A1
(43) Pub. Date: Dec. 6, 2007

(54) SELF-HYDRATING, SELF-CROSSLINKING GUAR COMPOSITIONS AND METHODS

(76) Inventors: Subramanian Kesavan, East Windsor, NJ (US); Aziz Boukhelifa, Ewing, NJ (US); Phillipe Neyraval, Hamilton, NJ (US)

Correspondence Address: Mialeeka Williams;Rhodia Inc., 8 Cedar Brook Drive, CN 7500, Cranbury, NJ, 08512-7500, US

(21) Appl. No.: 11/756,718

(22) Filed: Jun. 1, 2007

Related U.S. Application Data
(60) Provisional application No. 60/809,969, filed on Jun. 1, 2006.

(51) Int. Cl. C09K 8/66

(52) U.S. Cl. 507/273; 507/211; 507/260; 507/275

(57) ABSTRACT

A self-hydrating, self-crosslinking dry composition is used to prepare a hydrated, crosslinked fracturing fluid upon addition of water, the composition comprising (A) guar powder or a guar derivative powder; (B) crosslinker selected from the group consisting of boric acid, borax, borate ore, boron ore, antimony compounds, aluminum compounds, zirconium compounds, and titanium compounds; and (C) slow dissolving alkaline buffer, wherein the crosslinker (B) is non-encapsulated.

### CROSS-REFERENCE TO RELATED APPLICATION

Priority of Provisional Application No. 60/809,969, filed Jun. 1, 2006, is claimed.

### BACKGROUND OF THE INVENTION

This invention relates to the field of compositions and methods of use of guar and guar derivatives as fracturing fluids in the oilfield industry.

Guar gum, or “guar,” as used herein, has numerous applications in the oil industry, particularly, as additives to fracturing, gravel packing and completion fluids. Common guar derivatives include hydroxyalkyl guar, carboxyalkyl guar, carboxyalkyl hydroxyalkyl guar, cationic guar, and hydrophobically modified guar.

During typical fracturing operations, guar and guar derivatives are generally first hydrated in a hydration tank at the optimum pH for hydration for about 5-15 minutes and then are introduced into a blender. One or more crosslinkers, such as borax, titanium, or zirconium, and buffer are added in the blender to attain the optimum crosslinking pH. Proppants are also added and then the crosslinked gel is injected into the wellbore.

Since the fracturing operation is done on a continuous basis, the need to add different additives at different times and locations makes the fracturing operation very complicated. The resultant crosslinked gel is used to transport into the fracture proppants, i.e., sand grains, beads, or other small pellets suspended in fracturing fluid.

For effective crosslinking, the guar needs to hydrate first before crosslinking can take place. If crosslinking occurs before hydration, then the guar will not hydrate and it will not form a three-dimensional gel network. Also, the optimum pH for guar hydration is significantly different from the guar crosslinking pH and so the additives are normally added at different times in the operation.

Large cost savings and convenience could be achieved by using a dry blend composition which contains all of the chemicals needed to prepare fracturing fluid in one dry granular packaged unit. Others have disclosed such dry compositions, i.e., a self-hydrating, self-crosslinking, composition for use in fracturing fluids but none have successfully achieved the objective.

U.S. Pat. No. 4,505,826 to Horton disclosed a mixture of dry ingredients which, under some conditions, is stated to be capable of crosslinking at temperatures in the range of 80° F. to about 130° F. Zirconium acetyl acetonate is used as the crosslinking agent.

Horton '826 requires that the crosslinking agent become active before the gelling composition is completely hydrated because, according to Horton, if crosslinking of that particular fluid system is begun before the gelling composition is completely hydrated, further hydration is essentially halted and peak viscosity will never be reached, resulting in an inferior fluid.

Qiu, et al., U.S. Pat. No. 5,981,446, disclosed a composition where hydration and crosslinking of a fracturing fluid composition occur simultaneously. Qiu, et al., cited an attempt in 1974-1975 wherein a fracturing fluid system comprised of liquid components and solid granular components believed to have been about: (1) 80 wt % guar, (2) a buffer having 3.3 wt % citric acid, 3) 6.66 wt % sodium acetate, (3) 8.0 wt % magnesium oxide, and (4) 2 wt % silica flour, and was crosslinked with (5) liquid boric acid, wherein the liquid boric acid was added in “liquid add” form at the blender just prior to pumping the mixture downhole.

Qiu, et al., '446 disclosed and claimed a dry blend consisting of particulate hydratable polysaccharide formed of discrete particles and encapsulated particulate crosslinking agent selected from encapsulated borates, zirconates, titanates, antimony, and aluminum, a liquid slow releasing base such as magnesium oxide, calcium oxide, or strontium oxide, and, mixing the dry blend in a blending device with a liquid to form a first composition. After blending, the first composition is discharged through a tubular and develops an effective viscosity in the tubular and in the subterranean formation, the time required to mix and blend being no greater than about 3 minutes and, more preferably, no greater than about 1 minute. Qiu, et al., '446 also disclose dry blends which include a combination of unencapsulated and encapsulated borate crosslinker with reduced crosslinking time versus using only encapsulated borate, but reported lower viscosity, inhibited hydration, and inferior fluid texture as the ratio of unencapsulated borate to encapsulated borate was increased.

The Qiu, et al., '446 compositions and methods have not achieved commercial success, perhaps because of the cost and non-uniform distribution of encapsulated borate cross-linkers.

Exceptionally fast hydrating guars and guar derivatives have been disclosed in our U.S. Patent Publication Nos. 2006/0073988 on Apr. 6, 2006, and 2006/0068994 on Mar. 30, 2006, both presently assigned to Rhodia, Inc., which are hereby incorporated by reference.

There is a need to have a single package that will hydrate and crosslink that can be added to the blender and then injected into the wellbore, where the self-hydrating, self-crosslinking package is uniform and dissolves quickly. There is also a need in this art for a lower cost dry package having a more uniform distribution of cross-linker.

### SUMMARY OF THE INVENTION

These needs, and others as will become apparent from the following disclosure, are achieved by the present invention wherein a single package contains fast hydrating guar, non-encapsulated crosslinker, crosslinking buffer, and optional hydration buffer. By using a fast hydrating guar and a slow dissolving crosslinking buffer, there is sufficient time allowed for the guar to hydrate before the non-encapsulated crosslinker is activated and forms crosslinks. The formulation can be adjusted to target any desired crosslinking time. By using a single package, there is no need to add several different additives at several locations and at different times. This single package considerably simplifies the operation, for example by completely eliminating the conventionally needed hydration tank.

The guar or guar derivative powders used in compositions are preferably prepared by milling guar or a guar derivative for sufficient time so as to reduce the D50 particle size to less than 60μ, more preferably less than 40μ. Suitable guar powders reach at least 30% hydration within 60 seconds at about 70 degrees F. Preferred guar powders reach at least 50%, more preferably at least 70% hydration in 60 seconds at about 70 degrees F.

Either underivatized guar, referred to as “guar,” or derivatized guar can be used. Derivatized guars are any known in the art, for example hydroxyalkyl guar, carboxyalkyl guar, carboxyalkyl hydroxyalkyl guar, cationic guar, and hydrophobically modified guar. The guar can also be genetically modified. The powder can comprise polygalactomannan.

Suitable non-encapsulated crosslinkers include, for example, soluble particulate powders such as orthoboric acid, borates such as borax, which is the salt form of boric acid, and boron ores, especially refined ores such as colmenite and ulexite. Antimony, aluminum, zirconium or titanium are also suitable for use as crosslinkers. We have discovered that non-encapsulated crosslinkers which dissolve readily perform in this application far better than encapsulated crosslinkers and mixtures of encapsulated and non-encapsulated crosslinkers.

Suitable hydration buffers include, for example, fumaric acid, sulfamic acid, citric acid, adipic acid, acetic acid, and/or other low pH buffers. The hydration buffer is optional, but preferred. Suitable amounts of hydration buffers, when present, are up to 20 parts, preferably 0.1 to 10 parts, based on 100 parts guar.

The hydrating step is preferably conducted in the presence of one or more surfactants and buffers. In oilfield applications, typical oilfield additives such as salts, clay stabilizers, surfactants, emulsifiers and demulsifiers would be used and hydration can be in water or completion brines. Completion brines are concentrated brines of salts such as ammonium chloride, sodium chloride, potassium chloride, sodium bromide, potassium bromide, calcium chloride, calcium bromide, zinc bromide or mixtures of the above.

In drilling and fracturing fluid oilfield applications, the guar and crosslinker composition can be hydrated and crosslinked without the use of the typical hydrating tank. The resultant well-treating fluid is then introduced to a wellbore at a temperature and a pressure sufficient to treat the subterranean formation

The powder-non-encapsulated crosslinker composition has other utilities beyond the preferred fracturing fluid utility. For example, the composition can be an agent in any host product where faster hydration and crosslinking is desirable, for example (a) drilling fluid; (b) fracturing fluid; (c) animal litter; (d) explosive; (e) foodstuff; (f) paperstock; (g) floor covering; (h) synthetic fuel briquettes; (i) water thickener for firefighting; (j) shampoo; (k) personal care lotion; (l) household cleaner; (m) catalytic converter catalyst; (n) electroplating solution; (o) diapers; (p) sanitary towels; (q) super-adsorbent in food packaging; (r) sticking plasters for skin abrasions; (s) water-adsorbing bandages; (t) foliar spray for plants; (u) suspension for spraying plant seeds; (v) suspension for spraying plant nutrients; (w) flotation aid; (x) flocculent; (y) gravel packing fluid; and (z) completion fluid.

In designing chemistry and equipment for continuous mix fracturing, a major concern is the short time frame in which events must occur. For example, in typical South Texas fracturing treatments, it is not unusual for treatment rates to be as high as 70 BPM (barrels per minute), or about 3000 gal./min. This quantity of fluid flow is very large and, at this high rate, a typical guar metering rate would be 120 lb/min and a typical proppant rate could be over 11,000 lb/min.

Hydration time is a very significant factor in designing equipment and providing the appropriate amount of mixing energy. The equipment must be portable, and must conform to weight and dimensional regulations for road transport. Fast hydration is greatly preferred. Hydration must occur rapidly, and the fluid and equipment must be designed to afford a very quick hydration time, with large rates of flow. To achieve this objective, the fluid is advantageously hydrated in the tubular itself on its way down to the fracturing zone, and crosslinking can overlap in time with hydration.

Preferably, mixing and blending above ground occurs in less than three minutes, most preferably in less 1.5 minutes. This facilitates the use of holding tanks and mixing and blending equipment having less bulk and weight, and therefore less cost. Further, development of viscosity of the first composition prior to pumping into the tubular (measured after discharge from the blender) is preferably at least 10 cp@100 sec.⁻¹. Additionally, the minimum viscosity preferred to be attained by the fluid as it enters the fracture in the subterranean formation, as measured by laboratory simulation, is at least 50 cp@100 sec.⁻¹. Viscosity is needed downhole to adequately fracture the formation face, and to carry proppant downhole into the fracture.

### EXAMPLES

The following examples illustrate a few embodiments of the invention and compare the invention to other formulations. All parts and percentages are by weight unless otherwise indicated.

### Example 1

A single self-hydrating, self-crosslinking dry package of formulated guar was made by mixing 100 parts guar, 20 parts reagent grade magnesium oxide as slow dissolving high pH buffer, 8 parts orthoboric acid as non-encapsulated crosslinker, and 2.8 parts sulfamic acid as low pH hydration buffer. The dry package hydrated rapidly when added to water and crosslinked to form a gel without the addition of any further ingredients. The guar, referred to herein as Guar 1, was prepared by jetmilling underivatized guar with a final D50% (μm) particle size of 15 and D90% (μm) particle size of 30. The resultant Guar 1 reached a viscosity of 26.8 cP in 1 minute and % hydration of 85 in 1 minute. The viscosities after 1, 2, 3, 4, 5, 10 and 60 minutes are 26.8, 29, 29.8, 30.2, 30.4, 31 and 31.4 cP. Then 1.5 gm of this Guar 1 formulation was added to 250 ml of deionized water in a Waring blender (500 ml jar) and the speed was adjusted to about 2800 rpm. 1.5 gm of formulated guar 1 is added to the blender. A crosslinked gel was successfully formed in about 30 seconds.

### Example 2

Example 1 was repeated, except that Guar 2 was used instead of Guar 1. Guar 2 was also an underivatized guar having a molecular weight of 2.32×10⁶, D_{50%} (μm) particle size 34.77, D_{90%} (μm) particle size 69.96, viscosity cP at 17.0, 22.4, 25.0, 27.0 28.0, 30.0, and 33.0, respectively, after 1, 2, 3, 4, 5, 10, and 60 minutes, and % hydration of 52, 68, 76, 82, 85, 91, and 100, respectively, after the same time intervals. A weak, but acceptable, gel was formed in about 30 seconds.

### Example 3

Four dry formulations, A, B, C, and D, as set forth in Table I, were prepared by mixing the dry components, using either Guar1, Guar2, Guar3, or HPG, respectively. Guar1 and Guar2 were fast acting as described in Examples 1 and 2. HPG was a derivatized guar powder. Guar3 was an underivatized guar with a D_{50%} (μm) particle size of 48.77, D_{90%} (μm) particle size 91.44, viscosity cP at 16.4, 26.6, 33.6, 36.4, 39.4, 45.6, & 48.2, respectively, after 1, 2, 3, 4, 5, 10, & 60 minutes, and % hydration of 34, 55, 70, 76, 82, 95 & 100, respectively, after the same time intervals. The crosslinker was unencapsulated orthoboric acid. No encapsulated crosslinker was included. Magchem 30, a technical grade of magnesium oxide from Martin Marietta Magnesia specialties and was used as the slow dissolving high pH buffer in formulations A-D. Formulations A-D were dry blended.

TABLE I

| | Formulation A | Formulation B | Formulation C | Formulation D |
|---|---|---|---|---|
| Polymer | 12 gm of guar1 | 12 gm of guar2 | 12 gm of guar3 | 1.2 gm of HPG |
| | | | | (d50~55 microns, |
| | | | | d90~99 microns) |
| Crosslinker | 1 gm of | 1 gm of | 1 gm of | 0.1 gm of |
| | orthoboric acid | orthoboric acid | orthoboric acid | orthoboric acid |
| Slow | 0.5 gm of | 0.5 gm of | 0.5 gm of | 0.05 gm of |
| dissolving | Magchem 30 | Magchem 30 | Magchem 30 | Magchem 30 |
| high pH buffer | | | | |
| Low pH acid | 0.1 gm of | 0.1 gm of | 0.1 gm of | 0.01 gm of |
| | fumaric acid | fumaric acid | fumaric acid | fumaric acid |

### Example 4

1.25 gm of formulation A was added to 250 gm of deionized water in a blender and mixed for 30 seconds at 2800 rpm. This fluid formed a crosslinked gel in about 3 minutes. The pH of the sample was monitored as a function of time with the results set forth in Table II.

TABLE II

| | Time(min) | | | | |
|---|---|---|---|---|---|
| | 1 | 2 | 3 | 4 | 5 |
| pH | 6.1 | 7.1 | 7.9 | 8.1 | 8.25 |

The results of this experiment show that the slow dissolving high pH buffer, Magchem 30, is effective in keeping the pH initially low to allow sufficient hydration and then slowly increases the pH, which activates the crosslinker to form a gel.

### Example 5

0.75 gm of formulation A was added to 250 gm of deionized water in a blender and mixed for 30 seconds at 2800 rpm. This fluid formed a crosslinked gel in about 8 minutes, with the results shown in Table III.

TABLE III

Time(min)

| | 1 | 2 | 3 | 4 | 5 | 8 |
|---|---|---|---|---|---|---|
| pH | 5.75 | 6.8 | 7.8 | 8.05 | 8.25 | 8.6 |

### Example 6

1.25 gm of formulation B was added to 250 gm of deionized water in a blender and mixed for 30 seconds at 2800 rpm. This fluid formed a crosslinked gel in about 4 minutes. The pH of the sample was monitored as a function of time with the results shown in Table IV.

TABLE IV

| | Time(min) | | | | |
|---|---|---|---|---|---|
| | 1 | 2 | 3 | 4 | 5 |
| pH | 5.9 | 6.95 | 7.7 | 8 | 8.15 |

### Example 7

0.75 gm of formulation b was added to 250 gm of deionized water in a blender and mixed for 30 seconds at 2800 rpm. This fluid formed a crosslinked gel in about 8 minutes with the results shown in Table V.

TABLE V

Time(min)

| | 1 | 2 | 3 | 4 | 5 | 8 |
|---|---|---|---|---|---|---|
| pH | 6.25 | 7.2 | 7.65 | 8.05 | 8.2 | 8.5 |

### Example 8

1.25 gm of formulation C was added to 250 gm of deionized water in a blender and mixed for 30 seconds at 2800 rpm. This fluid formed a crosslinked gel in about 4 minutes. The pH of the sample was monitored as a function of time, with the results shown in Table VI.

TABLE VI

| | Time(min) | | | | |
|---|---|---|---|---|---|
| | 1 | 2 | 3 | 4 | 5 |
| pH | 6.25 | 7.6 | 8.05 | 8.35 | 8.5 |

### Example 9

0.75 gm of formulation C was added to 250 gm of deionized water in a blender and mixed for 30 seconds at 2800 rpm. This fluid formed a crosslinked gel in about 7-8 minutes, with the results shown in Table VII.

TABLE VII

Time(min)

| | 1 | 2 | 3 | 4 | 5 | 8 |
|---|---|---|---|---|---|---|
| pH | 5.8 | 6.6 | 7.5 | 7.8 | 8.1 | 8.3 |

### Example 10

1.36 gm of formulation D was added to 250 gm of deionized water in a blender and mixed for 30 seconds at 2800 rpm. This fluid formed a crosslinked gel in about 3-4 minutes. The pH of the sample is monitored as a function of time with the results set forth in Table VIII.

TABLE VIII

Time(min)

| | 1 | 2 | 3 | 4 |
|---|---|---|---|---|
| pH | 7 | 7.4 | 7.9 | 8.1 |

### Example 11

1.25 gm of formulation C was added to 250 gm of deionized water in a blender and mixed for 30 seconds at 2800 rpm. The fluid was then placed in a beaker and then the viscosity measured at 5.11/sec using an OFITE Model 900 viscometer. The development of the viscosity was monitored as a function of time. The rapid development of viscosity is an indication of gel formation. The pH at the end of the test is about 9. The viscosity achieved at various time at 75 F. at various intervals was measured with the results set forth in Table IX.

TABLE IX
Viscosity vs. Time

| time(min) | Viscosity, cP @5.11/sec | T(F.) |
|---|---|---|
| 1 | 6.4 | 75 |
| 1.5 | 16 | 75 |
| 2 | 22.3 | 75 |
| 2.5 | 31.4 | 75 |
| 3 | 67 | 75 |
| 3.5 | 106 | 75 |
| 4 | 136 | 75 |
| 4.5 | 207 | 75 |
| 5 | 282 | 75 |
| 5.5 | 386 | 75 |
| 6 | 577 | 75 |
| 7 | 1892 | 75 |
| 8 | 2287 | 75 |
| 9 | 2720 | 75 |
| 10 | 3100 | 75 |

### Example 12

This example shows that a successful crosslinked gel can be obtained by adding the ingredients separately. 1.2 gm of guar3 and 0.01 gm of fumaric acid are added to 250 gm of deionized water and mixed at 2800 rpm. After 15 sec, 0.05 gm of boric acid and 0.1 gm of magchem 30 were added. The solution is mixed for another 30 sec. The fluid formed a crosslinked gel in about 3.5 to 4 minutes. The pH of the sample was monitored as a function of time with the results set forth in Table X.

TABLE X

Time(min)

| | 1 | 2 | 3 | 4 | 5 | 15 |
|---|---|---|---|---|---|---|
| pH | 5 | 6.6 | 7.4 | 7.9 | 8 | 8.7 |

This indicates that the different components can be added separately and even if the guar has not fully hydrated when the crosslinker is added, a crosslinked gel is formed if the pH of the system can be adjusted higher by using a slow dissolving high pH buffer.

### Example 13 (Comparative)

This comparative example shows that if the pH is increased rapidly before hydration, a good crosslinked gel will not be formed. The difference between Example 12 and Example 13 was the use of slow dissolving high pH buffer, Magchem 30 in Example 12 vs. an immediately acting high pH buffer, potassium carbonate solution, in Example 13. 1.2 gm of guar3 and 0.01 gm of fumaric acid are added to 250 gm of deionized water and mixed at 2800 rpm. After 15 sec, 0.05 gm of boric acid and 0.5 ml of 25% by weight potassium carbonate solution were added. The solution is mixed for another 30 sec. The fluid did not form a crosslinked gel. The pH of the sample was monitored as a function of time with the results set forth in Table XI.

TABLE XI

Time(min)

| | 1 | 2 | 3 | 4 | 5 | 15 |
|---|---|---|---|---|---|---|
| pH | 9 | 9.02 | 9 | 9 | 9 | 9 |

This indicates that if the pH is increased very rapidly in the presence of the crosslinker, hydration is prevented and a good crosslinked gel cannot be formed.

While the invention has been described and illustrated in detail herein, various alternative embodiments should become apparent to those skilled in this art without departing from the spirit and scope of the invention.

What is claimed is:

1. A self-hydrating, self-crosslinking dry composition useful in preparing a fracturing fluid upon addition of water, the composition comprising (A) guar powder or a guar derivative powder; (B) crosslinker selected from the group consisting of boric acid, borax, borate ore, boron ore, antimony compounds, aluminum compounds, zirconium compounds, and titanium compounds; and (C) slow dissolving alkaline buffer, wherein the crosslinker (B) is non-encapsulated.

2. The composition of claim 1 wherein (B) is borate ore selected from the group consisting of colemanite and ulexite.

3. The composition of claim 1 wherein the guar or guar derivative powder has a D₅₀ particle size of less than 40μ and upon addition of water reaches at least 50% hydration within 60 seconds at about 21° C.

4. The composition of claim 1 wherein the guar or guar derivative achieves about 70% hydration within 60 seconds at about 21° C.

5. The composition of claim 1 further including (D) hydration buffer selected from the group consisting of fumaric acid, sulfamic acid, adipic acid, citric acid, and acetic acid.

6. The composition of claim 1 wherein the slow dissolving alkaline buffer (C) is selected from the group consisting of magnesium oxide, calcium oxide, and strontium oxide.

7. The composition of claim 1 wherein the slow dissolving alkaline buffer (C) is magnesium oxide.

8. The composition of claim 1 comprising, per 100 parts by weight (A) guar, 1 to 20 parts by weight (B) non-encapsulated crosslinker, 1 to 25 parts by weight (C) slow dissolving alkaline buffer, 0 to 20 parts by weight (D) hydration buffer.

9. The composition of claim 1 comprising, per 100 parts by weight (A) guar, 1 to 20 parts by weight (B) non-encapsulated crosslinker, 1 to 25 parts by weight (C) slow dissolving alkaline buffer, 0.1 to 10 parts by weight (D) hydration buffer.

10. A method of preparing a hydrated, crosslinked fracturing fluid comprising combining water or completion brine with a dry composition according to claim 1.

11. A method of preparing a hydrated, crosslinked fracturing fluid comprising combining water or completion brine in any sequence with (A) guar powder or a guar derivative powder; (B) crosslinker selected from the group consisting of boric acid, borax, borate ore, boron ore, antimony compounds, aluminum compounds, zirconium compounds, and titanium compounds; and (C) slow dissolving alkaline buffer, wherein the crosslinker (B) is non-encapsulated.

12. A method of fracturing an oil or gas containing subterranean formation comprising preparing a hydrated, crosslinked fracturing fluid by adding water or completion brine to the composition of claim 1 without use of a hydrating tank, adding propants, and introducing the resultant hydrated, crosslinked fluid into an oil or gas well.
